(19) United States
(12) Patent Application Publication
(10) Pub. No.: US 2026/0099871 A1
(43) Pub. Date: Apr. 9, 2026

(54) INTENT-DRIVEN ADAPTIVE RECOMMENDATION FOR AN ENHANCED USER ENGAGEMENT

(71) Applicant: Kyndryl, Inc., New York, NY (US)

(72) Inventors: Omar Odibat, Cedar Park, TX (US); Glincy Mary Jacob, Chengannur (IN); Manish Mitruka, Pune (IN); Reagan Mitchell, Austin, TX (US); Geetha R Subramanyam, Nagari (IN); Umar Mohamed Iyoob Umar, Manor, TX (US)

(21) Appl. No.: 18/907,624

(22) Filed: Oct. 7, 2024

(51) Int. Cl. G06Q 30/0601

(52) U.S. Cl. CPC G06Q 30/0631

(57) ABSTRACT

A technique for predicting and recommending service offerings includes obtaining an initial dataset related to a user interaction with an online recommendation system during a user online session, generating a predicted intent of the user online session, and generating an initial set of recommendations based on the predicted intent of the user online session. The technique includes ranking the initial set of recommendations to generate a set of ranked recommendations, generating a predicted sequence of actions of the user, and determining that the ranked set of recommendations are to be re-ranked into a re-ranked set of recommendations. The technique includes generating a semantically customized ranked set of recommendations using at least one of the ranked set of recommendations or the re-ranked set of recommendations and providing the semantically customized ranked set of recommendations to the user.

### BACKGROUND

The present invention relates generally to a recommendation system, and more particularly, to an intent-driven adaptive recommendation system and method having real-time session analysis and language personalization to provide an enhanced user engagement.

A recommendation system is a class of machine learning that uses data to help predict, narrow down, and find what people are looking for among an exponentially growing number of options. Typically, a recommendation system uses an artificial intelligence or Artificial Intelligence (AI) algorithm, usually associated with machine learning that uses readily available extremely large datasets of information to suggest or recommend items, such as products or services, to consumers. These recommendations can be based on various criteria, including past purchases, search histories, demographic information, and other factors. Accordingly, recommendation systems are highly useful as they help users discover products and services they might otherwise have not found on their own and as they help companies market and sell products and services to a wider variety of users.

Thus, recommendation systems are trained to understand the preferences, previous decisions, and characteristics of users by using data gathered about their interactions. These include impressions, clicks, likes, and purchases. Because of their capability to predict consumer interests and desires, recommendation systems are utilized by content and product providers. Recommendation systems can drive consumers to a product or service that interests them, from books to videos to health classes to clothing.

### SUMMARY

Embodiments are directed to a computer implemented method for predicting and recommending service offerings which include, in response to receiving an initial dataset related to a user interaction with an online recommendation system during a user online session, generating a predicted intent of the user online session and generating an initial set of recommendations based on the predicted intent of the user online session. The method includes ranking the initial set of recommendations to generate a set of ranked recommendations, generating a predicted sequence of actions of a user based on the predicted intent of the user online session, and determining that the ranked set of recommendations are to be re-ranked into a re-ranked set of recommendations based on the predicted sequence of actions. Further, the method includes generating a semantically customized ranked set of recommendations using the re-ranked set of recommendations and providing the semantically customized ranked set of recommendations to the user.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is an overall block diagram illustrating an Intent-Driven Adaptive Recommendation System (IDARS), according to one or more embodiments of the present invention;

FIG. 3 is a block diagram illustrating an Intent Recognition Module (IRM) for use with the IDARS of FIG. 2, according to one or more embodiments of the present invention;

FIG. 4 is a block diagram illustrating an Initial Recommender module (IR) for use with the IDARS of FIG. 2, in accordance with one or more embodiments of the present invention;

FIG. 5 is a block diagram illustrating an Action Sequence Generation Module (ASGM) for use with the IDARS of FIG. 2, in accordance with one or more embodiments of the present invention;

FIG. 6 is a block diagram illustrating a Recommendation Re-Ranking Module (RRRM) for use with the IDARS of FIG. 2, in accordance with one or more embodiments of the present invention;

FIG. 7 is a block diagram illustrating a Recommendations Generation Module (RGM) for use with the IDARS of FIG. 2, in accordance with one or more embodiments of the present invention;

FIG. 8 is a block diagram illustrating a method for recommending service offerings using an Intent-Driven Adaptive Recommendation System (IDARS) having Real-Time Session Analysis and Language Personalization Capabilities, in accordance with one or more embodiments of the present invention;

FIG. 9 depicts a cloud computing environment according to one or more embodiments of the present invention; and

FIG. 10 depicts abstraction model layers according to one or more embodiments of the present invention.

### DETAILED DESCRIPTION

One or more embodiments are configured and arranged to provide an intent-driven adaptive recommendation system using real-time session analysis and language personalization to provide an enhanced user engagement.

As noted herein, current recommendation systems are trained to understand the preferences, previous decisions, and characteristics of users by using data gathered about their interactions. Because some customers may have groups of users (e.g., teams) which include a plurality of different types of users (e.g., personas), current general recommendation models and systems are not able to capture information about each specific user in a team of users for a specific customer. Thus, current recommendation models and systems are unable to tailor recommendations to specific users based on user/team information. Accordingly, recommendations which are presented by the current models are static and do not consider the intent of the session or the dynamic set of actions performed by each specific user in a team during a session. As such, the contents of a recommendation are not user specific based on a role or based on an intent of a user and the same recommendations are typically offered to all users in the same format and language. As discussed briefly above, current recommendation models and systems are unable to capture information about each specific user in a team of users for a specific customer.

One or more embodiments of the invention include a system and method that provide an Intent-Driven Adaptive Recommendation System (IDARS) with real-time session analysis and language personalization capabilities to provide an enhanced user engagement. One or more embodiments of the invention may include intent recognition based on activities of similar customers and team members within the same organization using data that is visible on the console/user interface (UI) of the user session and on modeling the action sequence of the user using concepts of erosion, dilation and action sequence generation during the user session. Moreover, one or more embodiments provide dynamic recommendation by re-ranking using supporting collateral during a user session based on changes in the intent of the session and the actions of the user to influence the user's actions. This allows for engagement and communication recommendations using language commensurate with the ability and tone of the user based on the persona and the maturity of the user.

This also allows for recommendations to be goal oriented by tailoring the recommendations to be directed to the right products and services and presented to the right users at the right time and in the right language. Accordingly, one or more embodiments provide an AI-based solution that addresses the challenges of recommending the right products and services to the right users in an effective manner, where the solution includes an Intent Recognition Module (IRM) which includes an Initial Recommender module (IR), an Action Sequence Generation Module (ASGM), a Recommendations Re-Ranking Module (RRRM) and a Recommendations Generation Module (RGM).

In an embodiment, the Intent Recognition Module (IRM) receives and applies the historical activity of users on a team during previous sessions to an AI model to predict intent of the current session. For example, the IRM may predict intent related to the purchase of products and services, intent related to upgrades/renewals/retirement of services/products, intent related to searching of products and services, etc. Once the IRM generates an intent prediction, the Initial Recommender module (IR) within the IRM processes this prediction and generates an initial recommendation based on the predicted intent of the user. During the current session, the method includes monitoring and modeling the action sequence of the user based on the changes in the intent of the user using the Action Sequence Generation Module (ASGM) which applies concepts of erosion, dilation and action sequence generation. Also, during the current session, the Recommendations Re-Ranking Module (RRRM) determines whether the set of recommendations need to be re-ranked, and if so, generates a re-ranking request signal which is communicated to an LLM model that re-ranks and re-orders the set of recommendations. The set of recommendations are communicated to the user using subject matter language that is commensurate with the characteristics of the user.

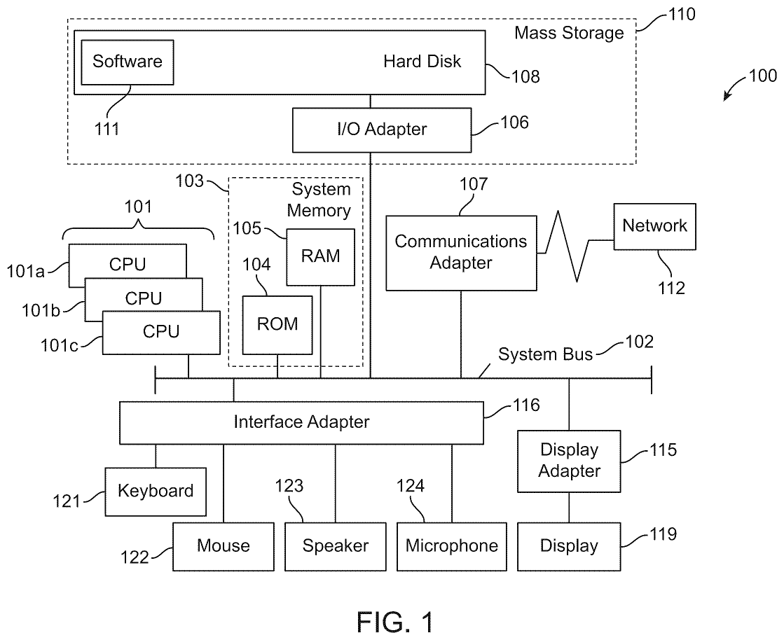

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by biological neural networks in nature. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

As discussed briefly hereinabove, one or more embodiments of the invention provide a new intent-driven adaptive recommendation system having real-time session analysis and language personalization for enhanced user engagement. An embodiment includes intent recognition based on activities of similar users and team members in the same organization using data visible on the console/UI on the user session and modeling the action sequence of the (specific) user using the concepts of erosion and dilation and action sequence generation during the user session. Dynamic recommendation re-ranking is applied using supporting collateral to influence user actions and engagement based on changes in user intent and actions. An appropriate set of language terms which are consistent with the ability and tone of the user are identified based on the subject matter of the user session on the persona and the maturity of the user.

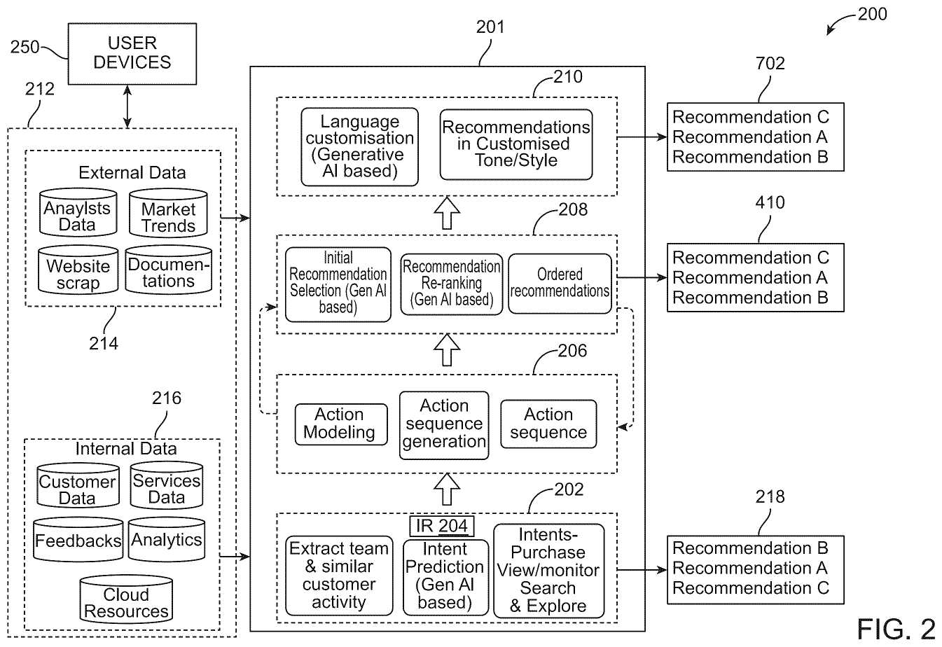

Referring to FIG. 2, an embodiment of the invention includes an Intent-Driven Adaptive Recommendation System (IDARS) 200 with real-time session analysis and language personalization capabilities to provide an enhanced user engagement during an online session and a method for implementing the IDARS 200 during that session. In accordance with an embodiment, the IDARS 200 can include software 201 having a plurality of software modules which include an Intent Recognition Module (IRM) 202 containing an Initial Recommender module (IR) 204, an Action Sequence Generation Module (ASGM) 206, a Recommendations Re-Ranking Module (RRRM) 208 and a Recommendations Generation Module (RGM) 210.

The IDARS 200 can be representative of one or more computer systems such as the computer system 100. Moreover, the IDARS 200, software 201, IRM 202, IR 204, ASGM 206, RRRM 208, RGM 210, user devices 250, etc., can include functionality and features of the computer system 100 in FIG. 1 including various hardware components and various software applications such as software 111 which can be executed as instructions on one or more processors 101 in order to perform actions according to one or more embodiments of the invention. The software 201 can include, be integrated with, and/or call other pieces of software, algorithms, application programming interfaces (APIs), graphical user interfaces (GUIs) etc., to operate as discussed herein.

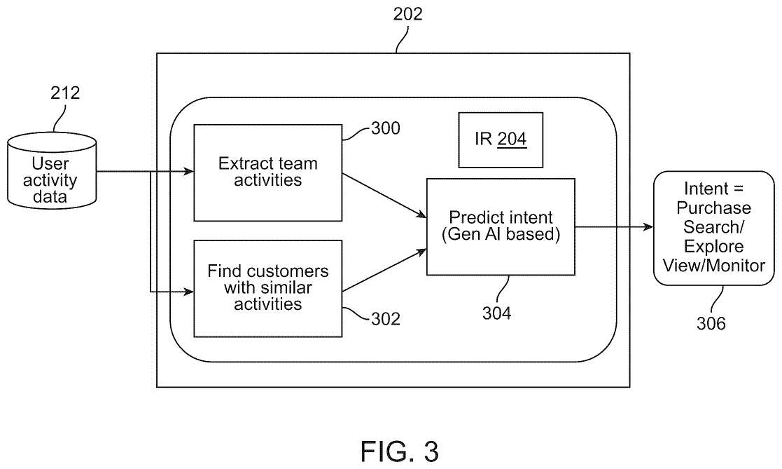

In an embodiment, the IDARS 200 can introduce user/session activity data 212 related to the topic of the online session into the Intent Recognition Module (IRM) 202 of the IDARS 200, where the user/session activity data 212 includes external data 214 and internal data 216 about one or more users/team members in the same organization. The users/teams utilize respective user devices 250 for online sessions, and the user/session activity data 212 is captured for the online sessions. The external data 214 includes data that was collected from external data sources about the users and/or topic of the online search session, such as analyst data, market trend data, website scrap data and other documentation data. The internal data 216 includes data collected from internal sources about the users and/or topic of the online session, such as customer/user data, services data, feedback data, analytic data and cloud resource data. It should be appreciated that one or both of the external data 214 and internal data 216 can include the historic activity of the one or more users during previous online sessions. This historic activity may include data related to previous purchase history (including related services and relevant customer stories), viewing/monitoring service history (including upgrades to newer versions of services and renewing/retiring of current resources), and search/explore history (including requests for demonstrations and/or scheduling of consultations). Further details of the IRM 202, the IR 204, the ASGM 206, the RRRM 208, and the RGM 210 are respectively depicted in FIGS. 3, 4, 5, 6, and 7 discussed herein.

Referring to FIG. 3, an embodiment of the Intent Recognition Module (IRM) 202 which includes the Initial Recommender module (IR) 204 is shown, where the user/session data 212 is introduced into the IRM 202. The IRM 202 processes the user/session data 212 to extract user/session activity data for the users/team at block 300 (using data visible on the console/UI of the online session) and/or to identify customers having customer user/session activity data that is similar to user/session activity data at block 302. This user/session activity data and customer user/session activity data are then applied to a generative AI model 304 which processes the user/session activity data and the customer user/session activity data to recognize and predict an intent of the current online session based on the activities of similar customers and the users/team members, as predicted intent 306.

For example, the IRM 202 may predict intent related to one or more of a plurality of intent purposes, such as the purchase of products and services, upgrades/renewals/retirement of services/products, and searching of products and services, related services and relevant customer stories and request for demonstrations/consultation scheduling. Accordingly, the IDARS 200 obtains historical data responsive to user/team activity from previous sessions. One way this may be accomplished is by communicating with the websites that the user/team has communicated with in previous sessions to obtain data responsive to their online interaction history. Using this information, the IRM 202 may extract the past activities of the user/team (such as previous strategy results, user summary, etc.) and locate customers having similar activities. Using commonly available generative AI based models, the IRM 202 then generates a prediction of the intent of the online session of the user device 250 as predicted intent 306. Once the prediction of the intent of the online session is generated, the prediction is introduced to the Initial Recommender module (IR) 204.

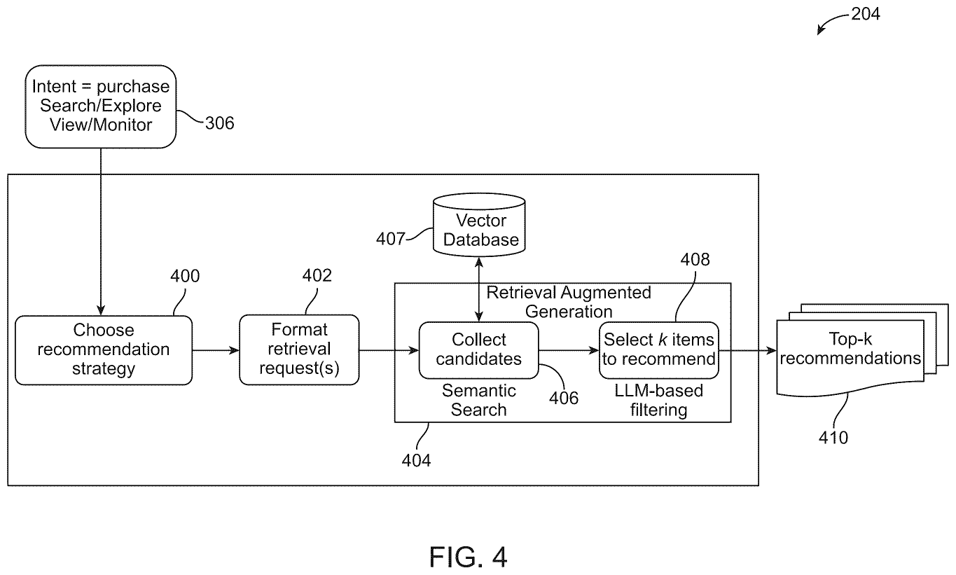

Referring to FIG. 4, an embodiment of the Initial Recommender module (IR) 204 is shown and receives the predicted intent 306 generated by the IRM 202. The IR 204 then generates an initial set of ranked recommendations using the predicted intent, the action history, the previous strategy results and a user summary (which may be generated using a user's activity history), by first choosing a recommendation strategy 400. The recommendation strategy may be chosen from the following recommendation strategies: 1) showing products that are similar, 2) showing products that are compatible with defined characteristics, 3) showing products by category and 4) showing one product per category. It should be appreciated that, based on the previous factors, a strategy template may be selected alongside items that satisfy variables in the chosen template. This may be accomplished by using general guidelines for selections which may be defined through prompts. For example, if the intent is to “purchase”, one option might be to identify items that were recently purchased and to find compatible unpurchased products (e.g., strategy #2 above). On the other hand, if the intent is to “search & explore”, the strategy model may consider whether recently browsed items, belong to a common category (e.g., strategy #3 above); if the items are dissimilar, the IRM module 204 can select several categories (e.g., strategy #4 above)

Once a recommendation strategy template is chosen and a list of reference items (e.g., data which is used to fill variables in the chosen recommendation strategy template) are determined, the IR 204 then generates a format retrieval request 402 to identify an appropriate format for the recommendation strategy. Once an appropriate format for the retrieval request is identified, the IR 204 performs a Retrieval Augmented Generation (RAG) process 404 by collecting suitable semantic candidates 406. This may be accomplished by conducting a semantic search of a vector database 407 with potentially suitable semantic terms, where the collected suitable semantic candidates are based on the subject matter of the session/interaction. It should be appreciated that the number of candidates returned may be a multiple (F) of the number of final recommendations. The selection (generation) stage in the RAG process 404 may serve to re-integrate contextual information about the user/team and browsing history and then select the items among the candidates that best fit the context of the recommendation strategy. Additionally, the selection (generation) stage may also serve to enforce the selection criteria, such as avoiding redundant items.

The RAG 404 then selects a k number of semantic terms to recommend 408 (where the selected k number of semantic terms may be based on the intent prediction, user action history, previous strategy results and the user summary) by introducing the collected suitable semantic candidates to a Large Language Model (LLM) AI filtering software which filters the collected suitable semantic candidates based on semantic terms. It should be appreciated that this may be accomplished using commonly available LLMs. The RAG 404 then identifies the initial top k recommendations 410 from the selected k number of semantic terms to recommend 408. In one or more embodiments, the RAG 404 identifies the initial top k recommendations 410 from the selected k number of semantic terms based on the predicted intent of the user, the online history of the user, any previous strategy results and/or a user summary.

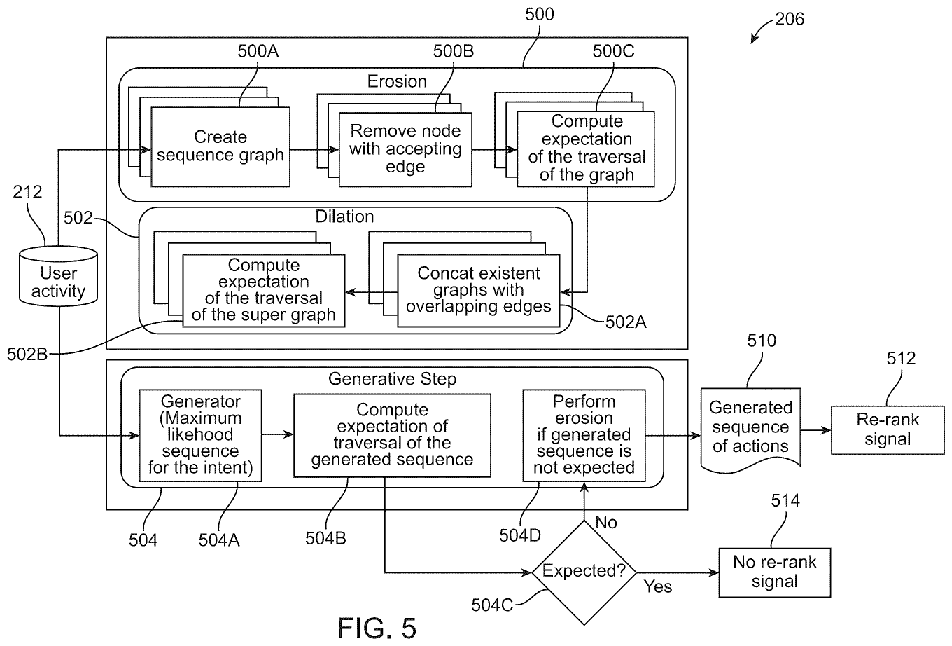

The process further includes introducing the user activity 212 to model an action sequence of the user/team via the Action Sequence Generation Module (ASGM) 206, as depicted in FIG. 2. Referring to FIG. 5, an embodiment of the Action Sequence Generation Module (ASGM) 206 is shown and includes the ASGM 206 receiving the user activity 212 (e.g., current online actions of the user operating the user device 250, previous sessions of the user and the user profile). The ASGM 206 can perform an erosion process 500 on the user activity 212 by processing the user activity 212 to create a plurality of sequence graphs at block 500A having a plurality of Action Vectors, where each Action Vector is a node on the sequence graph and where the Action Vector is given by:

$$Action Vector = AV ( a , t ) ,$$

where ‘a’ is the type of action (click, read, etc.) and ‘t’ is the relative time of the action. The ASGM 206 examines each of the nodes on the sequence graphs to identify the nodes having an accepting edge and removes the identified nodes from the sequence graphs at block 500B. The ASGM 206 then computes the expectations of the traversal of the sequence graphs at block 500C. The ASGM 206 then performs a dilation process 502 on the sequence graphs to create a super graph by concatenating sequence graphs having any overlapping edges at block 502A and by computing the expectation of the traversal of the super graph at block 502B. A generative step 504 is also applied to the user activity 212 to generate an expected sequence of actions 510 by processing the user activity 212 to generate a maximum likelihood of a sequence of actions for the predicted intent at block 504A and computing an expectation E(x) of the traversal of the generated maximum likely sequence of actions at block 504B. The generative step 504 then determines whether the generated likely sequence of actions is what was expected at block 504C given the intent prediction, the online history of the user, any previous strategy results and/or a user summary. If the generated likely sequence of actions is what was expected, the ASGM 206 may keep the likely sequence of actions 510 for further operations and no re-rank signal is sent at block 514. If the generated likely sequence of actions is not what was expected, the ASGM 506 may perform an erosion process (as discussed above) on the unexpected generated sequence of actions at block 504D, where the expectation E(x) is the likelihood of a weighted sum of the action that the generated sequence.

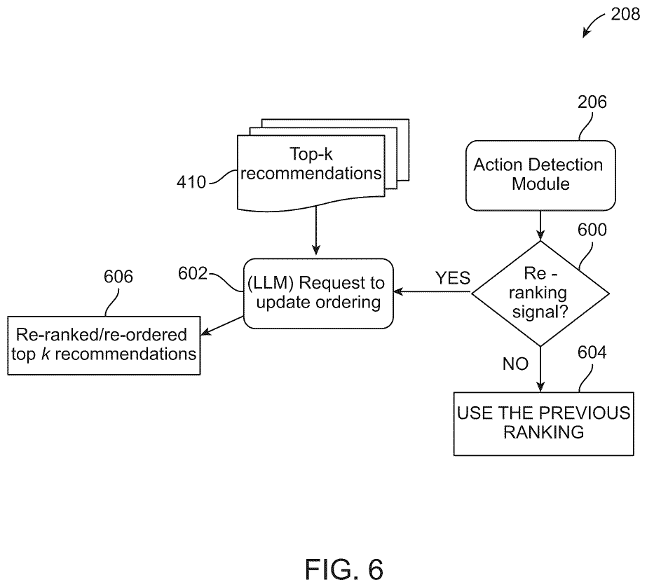

As briefly discussed hereinabove, if the generated maximum likely sequence of actions 504A is not what was expected, the ASGM 206 reperforms the erosion process 500 by recreating the sequence graph at block 500A of the generated maximum likely sequence of actions (where each Action Vector is a node on the sequence graph), removing the nodes having an accepting edge at block 500B and computing the expectation of the traversal of the sequence graph at block 500C. The ASGM 206 may then process this result using the dilation process 502 which concatenates the sequence graphs with overlapping edges at block 502A to generate a super graph and recomputes the expectation of the traversal of the super graph at block 502B. The ASGM 206 then determines whether the top k recommendations 410 should be re-ranked by comparing the generated sequence of actions 510 with the actual actions performed by the user/team. If the actual actions performed by the user/team are different from the generated sequence of actions 510, then the ASGM 206 generates a re-rank signal 512 and communicates the re-rank signal 512 to the Recommendation Re-Ranking Module (RRRM) 208. The re-rank signal 512 includes and/or activates instructions to re-rank the top k recommendations 410 as discussed further in FIG. 6.

Referring to FIG. 6, an embodiment of the Recommendation Re-Ranking Module (RRRM) 208 is shown, where the RRRM 208 is configured to receive the re-rank signal 512 from the ASGM 206. The RRRM 208 receives and examines the output of the ASGM 206 to determine whether the re-rank signal 512 has been received from the ASGM 206. When a re-rank signal has been received, the RRRM 208 communicates with a Large Language Model (LLM) 602 to cause the LLM 602 to obtain the currently ranked top k recommendations 410 and re-rank and re-order the currently ranked top k recommendations 410 to generate re-ranked/re-ordered top k recommendations 606. If the RRRM 208 determines that no re-rank signal (at block 514) has been received, then the RRRM 208 can use the currently ranked top k recommendations 410 at block 604 of the top k recommendations 410. The method can further include customizing the top k recommendations 410, 606 to conform to the ability, tone, persona and maturity of the user/team of the user/team.

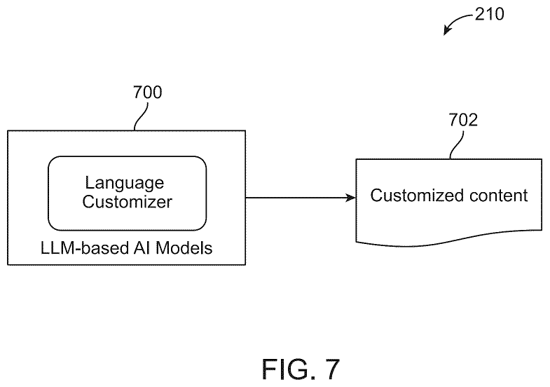

Referring to FIG. 7, an embodiment of the Recommendations Generation Module (RGM) 210 is shown, where the top k recommendations 410, 606 (either the currently ranked top k recommendations 410 or the re-ranked/re-ordered top k recommendations 606), along with user online session information is introduced into a Large Language Model (LLM) (using commonly available LLMs) language customizer 700. The LLM is instructed to customize the language of the top k recommendations 410, 606 by adjusting the language responsive to characteristics of the user/team, such as ability, tone, persona and maturity of the user/team and provides the customized recommendation 702 to the user/team. The session information may include user type (e.g., frequent, infrequent, new), the role of the user (e.g., technical, non-technical), the domain of the subject (e.g., software engineering, sales, management, etc.) and customer type (e.g., entry, standard, enterprise, etc.). In one or more embodiments, the IDARS 200 is configured to provide the (semantically) customized language of the top k recommendations 410, 606 to the specific user of the user device 250 for graphical display and interaction. For example, if the user is an expert in a technical field (such as electrical engineering), the language of the top k recommendations 410, 606 may be customized to include technical terms. Whereas if the user is a non-technical salesperson with no technical expertise, the language of the top k recommendations 410, 606 may be customized to include non-technical sales terminology.

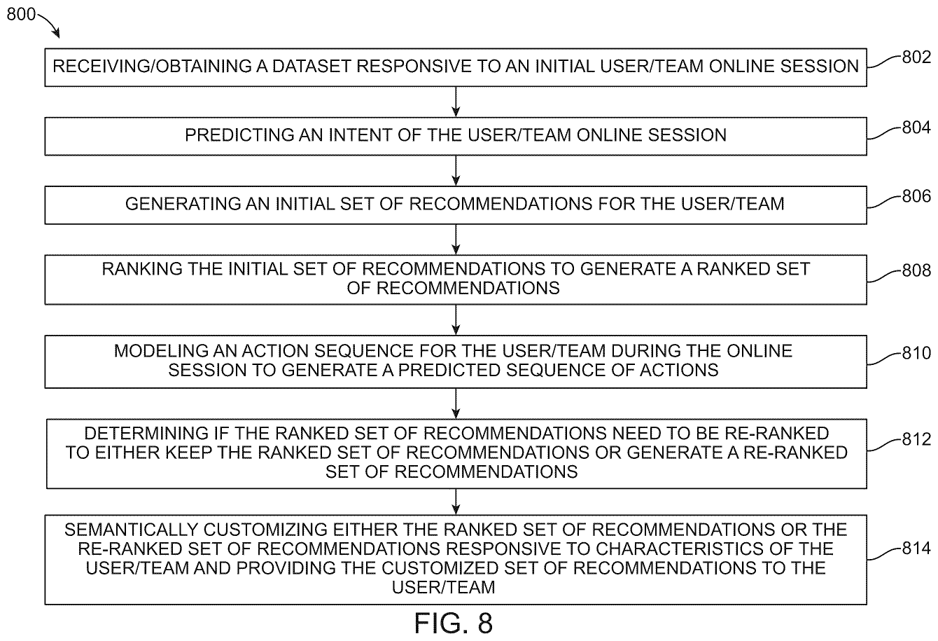

In an embodiment and referring to FIG. 8, an operational block diagram describing an embodiment of a computer-implemented method 800 for predicting service offerings based on an intent of a user/team by implementing an Intent-Driven Adaptive Recommendation System (IDARS) 200 with Real-Time Session Analysis and Language Personalization Capabilities to provide an enhanced user engagement is shown. As discussed herein, the IDARS 200 is a computer system, such as the computer system 100, configured to perform the method 800. The method 800 may include receiving a dataset 212 responsive to an initial user/team online session, as shown in operational block 802, where the dataset includes user/team online activity history, a set of internal data 214 and a set of external data 216. The set of internal data 214 may include at least one of customer data, services data, feedback data, analytics data, and cloud resources data, and the external data 216 includes at least one of analyst data, market trend data, website scraping data, and documentation data. The method 800 may include predicting an intent of the user/team online session, as shown in operational block 804, and generating an initial set of recommendations 218 of service offering predictions for the user/team, as shown in operational block 806, where the initial set of recommendations 218 of service offering predictions is based on a profile for the user/team and the predicted intent of the user/team online session. Additionally, the method 800 can include ranking the initial set of recommendations 218 to generate a ranked set of recommendations 410, as shown in operational block 808 and predicting a sequence of actions 510 by modeling an action sequence for the user/team during the (current) online session, as shown in operational block 810.

The method 800 further includes determining if the ranked recommendations 410 should be re-ranked and re-ordered by comparing the generated sequence of actions 510 with the actual actions performed by the user/team (during the current online session), as shown in operational block 812. If the actual actions performed by the user/team are different from the (expected) generated sequence of actions 510, then the ASGM 206 generates a re-rank signal 512 and communicates the re-rank signal 512 to the RRRM 208. The RRRM 208 then communicates with an LLM 602 to cause the LLM 602 to obtain the currently ranked top k recommendations 410 and re-rank and re-order the currently ranked top k recommendations 410 to generate re-ranked/re-ordered top k recommendations 606. If the RRRM 208 determines that no re-rank signal 514 has been received, then the RRRM 208 will not cause the LLM 602 to re-rank and re-order the currently ranked top k recommendations 410. The method 800 can further include introducing either the re-ranked/re-ordered top k recommendations 606 (if a re-rank signal is generated 512) or the currently ranked top k recommendations 410 (if a re-rank signal is not generated at block 514) into an LLM based AI language customizer 700 which semantically customizes the set of recommendations based on the ability, tone, persona and maturity of the user/team and provides the customized set of recommendations 702 to the user/team, as shown in operational block 814. Moreover, the method 800 or portions of the method 800 may be reperformed during the user/team online session using real-time data obtained during the user/team online session to dynamically re-rank and re-order at least one of the re-ranked/re-ordered top k recommendations 606 (if a re-rank signal was generated 512) or the currently ranked top k recommendations 410 (if a re-rank signal was not generated 514) to provide a dynamically generated updated set of top k recommended services offerings to the user/team on a real-time basis and/or the method 800 or portions of the method 800 may be re-performed at a proscribed time interval during the user/team online session to provide a continuously (or semi-continuously) updated dynamic set of recommended services offerings to the customer. The re-ranked/re-ordered top k recommendations 606 and the currently ranked top k recommendations 410 can be selectable objects displayed to the user in which the selectable object causes various actions on one or more computer systems of the user including the user device 250 and/or computers systems in a cloud computing environment. As example actions executed on the computer systems upon selection by the user, the selectable objects (for the re-ranked/re-ordered top k recommendations 606 and the currently ranked top k recommendations 410) may cause upgrades/renewals/retirement of services/products (including upgrades to newer versions of services and renewing/retiring) to computing resources in the computer systems of the user. Computing resources can include memory, processors, software executing on processors, input/output resources, operating systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Moreover, it should be appreciated that in one or more embodiments, the computer 100 in FIG. 1 may be used, in whole or in part, to practice one or more of the features of the invention. For example, in an embodiment, the computer 100 in FIG. 1 may be used to conduct a user online session and may contain the software modules 202, 206, 208 and 210 shown in FIG. 2 to practice aspects of the invention. The computer 100 in FIG. 1 may further include processors which execute instructions that practice the processes in FIG. 3-8, including the use of machine learning models, such as commonly available AI generative models (LLMs) and the use of reinforcement learning models used it in the steps of ranking and updating the dynamic set of recommendations.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

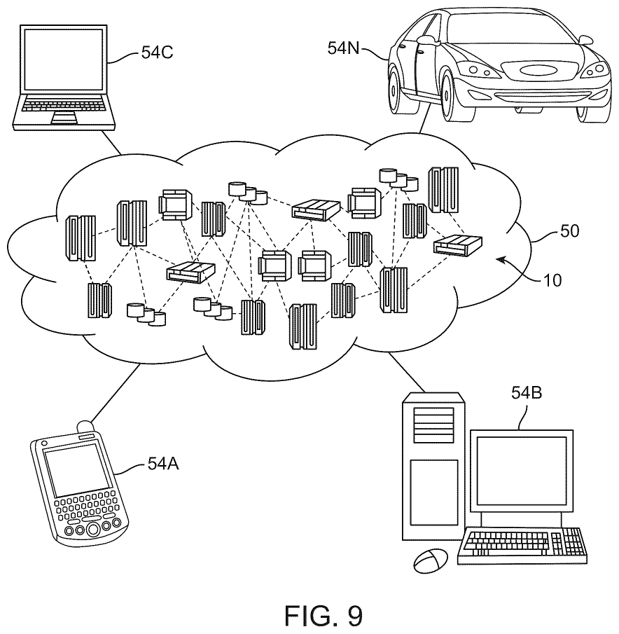

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

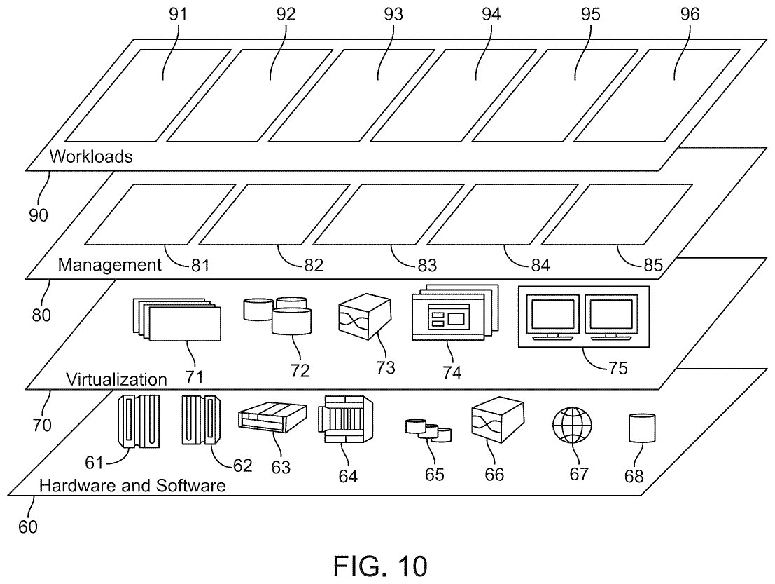

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer, include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 201, the software modules 202, 204, 206, 208, the LLM, the generative AI engines, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”The terms “about,” “substantially,” “approximately,” and variations thereof, are intended to include the degree of error associated with measurement of the particular quantity based upon the equipment available at the time of filing the application. For example, “about”can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computed implemented method comprising:
in response to receiving an initial dataset related to a user interaction with an online recommendation system during a user online session, generating a predicted intent of the user online session;
generating an initial set of recommendations based on the predicted intent of the user online session;
ranking the initial set of recommendations to generate a set of ranked recommendations;
generating a predicted sequence of actions of a user based on the predicted intent of the user online session;
determining that the ranked set of recommendations are to be re-ranked into a re-ranked set of recommendations based on the predicted sequence of actions;
generating a semantically customized ranked set of recommendations using the re-ranked set of recommendations; and
providing the semantically customized ranked set of recommendations to the user.

2. The computer implemented method of claim 1, wherein the initial dataset includes user online history data, internal data about the user collected from internal sources of the user, and external data about the user collected from external sources from the user.

3. The computer implemented method of claim 1, wherein the initial set of recommendations is based on a user profile and the predicted intent of the user online session.

4. The computer implemented method of claim 1, wherein the generating the semantically customized ranked set of recommendations using the re-ranked set of recommendations comprises inputting a characteristic of the user and the re-ranked set of recommendations to a language model.

5. The computer implemented method of claim 1, wherein the ranking the initial set of recommendations includes ranking the initial set of recommendations using the predicted intent, a user online activity history, and a previous strategy result.

6. The computer implemented method of claim 1, wherein the determining that the ranked set of recommendations are to be re-ranked is responsive to a re-rank signal generated in response to the predicted sequence of actions and actual user actions during the user online session.

7. The computer implemented method of claim 1, wherein the semantically customized ranked set of recommendations is responsive to an ability, a tone, a persona, and a maturity level of the user.

8. A system comprising:
a memory having computer readable program instructions; and
one or more processors for executing the computer readable program instructions, the computer readable instructions controlling the one or more processors to perform operations comprising:
in response to receiving an initial dataset related to a user interaction with an online recommendation system during a user online session, generating a predicted intent of the user online session;
generating an initial set of recommendations based on the predicted intent of the user online session;
ranking the initial set of recommendations to generate a set of ranked recommendations;
generating a predicted sequence of actions of a user based on the predicted intent of the user online session;
determining that the ranked set of recommendations are to be re-ranked into a re-ranked set of recommendations based on the predicted sequence of actions;
generating a semantically customized ranked set of recommendations using the re-ranked set of recommendations; and
providing the semantically customized ranked set of recommendations to the user.

9. The system of claim 8, wherein the initial dataset includes user online history data, internal data about the user collected from internal sources of the user, and external data about the user collected from external sources from the user.

10. The system of claim 8, wherein the initial set of recommendations is based on a user profile and the predicted intent of the user online session.

11. The system of claim 8, wherein the generating the semantically customized ranked set of recommendations using the re-ranked set of recommendations comprises inputting a characteristic of the user and the re-ranked set of recommendations to a language model.

12. The system of claim 8, wherein the ranking the initial set of recommendations includes ranking the initial set of recommendations using the predicted intent, a user online activity history, and a previous strategy result.

13. The system of claim 8, wherein the determining that the ranked set of recommendations are to be re-ranked is responsive to a re-rank signal generated in response to the predicted sequence of actions and actual user actions during the user online session.

14. The system of claim 8, wherein the semantically customized ranked set of recommendations is responsive to an ability, a tone, a persona, and a maturity level of the user.

15. A computer program product comprising a computer readable storage medium having computer readable program instructions embodied therewith, the computer readable program instructions executable by one or more processors to cause the one or more processors to perform operations comprising:
in response to receiving an initial dataset related to a user interaction with an online recommendation system during a user online session, generating a predicted intent of the user online session;
generating an initial set of recommendations based on the predicted intent of the user online session;
ranking the initial set of recommendations to generate a set of ranked recommendations;
generating a predicted sequence of actions of a user based on the predicted intent of the user online session;
determining that the ranked set of recommendations are to be re-ranked into a re-ranked set of recommendations based on the predicted sequence of actions;
generating a semantically customized ranked set of recommendations using the re-ranked set of recommendations; and
providing the semantically customized ranked set of recommendations to the user.

16. The computer program product of claim 15, wherein the initial dataset includes user online history data, internal data about the user collected from internal sources of the user, and external data about the user collected from external sources from the user.

17. The computer program product of claim 15, wherein the initial set of recommendations is based on a user profile and the predicted intent of the user online session.

18. The computer program product of claim 15, wherein the generating the semantically customized ranked set of recommendations using the re-ranked set of recommendations comprises inputting a characteristic of the user and the re-ranked set of recommendations to a language model.

19. The computer program product of claim 15, wherein the ranking the initial set of recommendations includes ranking the initial set of recommendations using the predicted intent, a user online activity history, and a previous strategy result.

20. The computer program product of claim 15, wherein the determining that the ranked set of recommendations are to be re-ranked is responsive to a re-rank signal generated in response to the predicted sequence of actions and actual user actions during the user online session.
